(19) United States
(12) Patent Application Publication
(10) Pub. No.: US 2019/0102852 A1
(43) Pub. Date: Apr. 4, 2019

(54) CAREER GUIDANCE SYSTEM

(71) Applicant: Oracle International Corporation, Redwood Shores, CA (US)

(72) Inventors: Egidio Loch Terra, San Mateo, CA (US); James Thomas McKendree, Elizabeth, CO (US); Paz Centeno, Delray Beach, FL (US); Catherine H. M. Kuo, Danville, CA (US); Boonchanh Oupaxay, Mountain House, CA (US); Richard Lee Krenek, Pleasanton, CA (US); David Anthony Madril, Denver, CO (US); Susan Jane Beidler, Oakland, CA (US)

(73) Assignee: Oracle International Corporation, Redwood Shores, CA (US)

(21) Appl. No.: 16/100,438

(22) Filed: Aug. 10, 2018

Related U.S. Application Data
(60) Provisional application No. 62/566,394, filed on Sep. 30, 2017.
(60) Provisional application No. 62/573,351, filed on Oct. 17, 2017.
(60) Provisional application No. 62/566,405, filed on Sep. 30, 2017.
(60) Provisional application No. 62/633,187, filed on Feb. 21, 2018.

(51) Int. Cl. G06Q 50/20; G06F 17/30; G06Q 10/10; G09B 19/00

(52) U.S. Cl. CPC G06Q 50/205; G09B 19/00; G06Q 10/1093; G06F 17/30283

(57) ABSTRACT

Operations include recommending and presenting career recommendations for students. The system makes a career recommendation based on a recommendation score computed based on student data and employee data. The employee data may be obtained from a variety of sources such as alumni surveys, job recruiting databases, and job market statistics. The system may recommend an employment position for a student, based on an academic program in which the student is enrolled. The system may recommend an academic program for a student, based on a target employment position. The system may present an interface for comparing multiple recommended academic programs or employment positions. The interface may display detailed information about one or more academic programs and/or employment positions.

### BENEFIT CLAIMS; INCORPORATION BY REFERENCE

This application claims the benefit of U.S. Provisional Application No. 62/566,394, filed Sep. 30, 2017; U.S. Provisional Patent Application No. 62/573,351, filed Oct. 17, 2017; U.S. Provisional Patent Application No. 62/566,405, filed Sep. 30, 2017; U.S.; and U.S. Provisional Patent Application No. 62/633,187, filed Feb. 21, 2018, which are hereby incorporated by reference.

### TECHNICAL FIELD

The present disclosure relates to higher education. In particular, the present disclosure relates to recommending employment for a student.

### BACKGROUND

One of the goals of a higher education institution is for students to succeed in finding the best jobs possible after graduating. To help students find suitable employment, institutions work to facilitate the connections between students and employers.

Academic institutions may maintain career systems. Career systems store employment data such as job openings and job requirements. Career services departments of academic institutions may use the career systems to facilitate student contact with employers. The career services departments may provide the students with directions on preferred methods for reaching out to each hiring company.

Academic institutions may also maintain academic data systems. Academic data systems store academic data such as student grades and completed coursework. The job data and academic data are generally not integrated into a same system.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2A illustrates a academic program view of an recommendation interface in accordance with one or more embodiments;

FIG. 2B illustrates a career exploration view of an recommendation interface in accordance with one or more embodiments;

FIG. 2C illustrates a planner view of an recommendation interface in accordance with one or more embodiments;

FIG. 3 illustrates example operations for recommending an academic program for a student, based on a target employment position, in accordance with one or more embodiments;

FIG. 4 illustrates example operations for recommending an employment position for a student in accordance with one or more embodiments; and

FIG. 5 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

1. GENERAL OVERVIEW

2. SYSTEM ARCHITECTURE

3. RECOMMENDATION INTERFACE

4. RECOMMENDING AN ACADEMIC PROGRAM FOR A STUDENT, BASED ON A TARGET EMPLOYMENT POSITION

5. RECOMMENDING AN EMPLOYMENT POSITION FOR A STUDENT

6. MISCELLANEOUS; EXTENSIONS

7. HARDWARE OVERVIEW

1. General Overview

Some embodiments determine and present career recommendations for students. The career recommendations may include academic programs or employment positions for a student. An academic program may include a major, minor, certificate program, or degree program. An employment position may include a particular job (e.g., engineer at Rocket Corp.) or a job field (e.g., aeronautical engineering).

Some embodiments recommend an academic program for a student, based on a target employment position. The system computes a recommendation score for each particular academic program based on suitability for the target employment position. The recommendation score for a particular academic program is based on a number of employees, with the target employment position, who completed the particular academic program. The recommendation score for a particular academic program may be further based on a comparison of coursework completed by the student and coursework required for the particular academic program. An academic program is recommended to a student if the corresponding recommendation score computed meets or exceeds a threshold value.

Some embodiments recommend an employment position for a student, based on a student's academic program. The system computes a recommendation score for each particular employment position based on a suitability for the student's academic program. The recommendation score for a particular employment position is based on a number of employees with the particular employment position who have completed the student's academic program. The recommendation score for the particular employment position may be further based on skills to-be-obtained by the student for obtaining the particular employment position. Additional factors for computing the recommendation score for an employment position may include salary data, employability, and student time investment associated with the employment position. An employment position is recommended for a student if the corresponding recommendation score meets or exceeds a threshold value.

Some embodiments present an interface for comparing multiple academic programs in view of a student's data. The information may include a recommendation score computed for each academic program as described above. The information may include a student's level of completion for the courses required for each academic program.

Some embodiments present an interface for comparing multiple employment positions. The information may include a number of employees, for each of the employment positions, that have completed the student's academic program. The information may include average salary and the student's estimated time for employment. The system may further identify and display job requirements or skills suggested for the student in obtaining each of the employment positions.

Some embodiments described in this Specification and/or recited in the claims may not be included in this General Overview section.

2. System Architecture

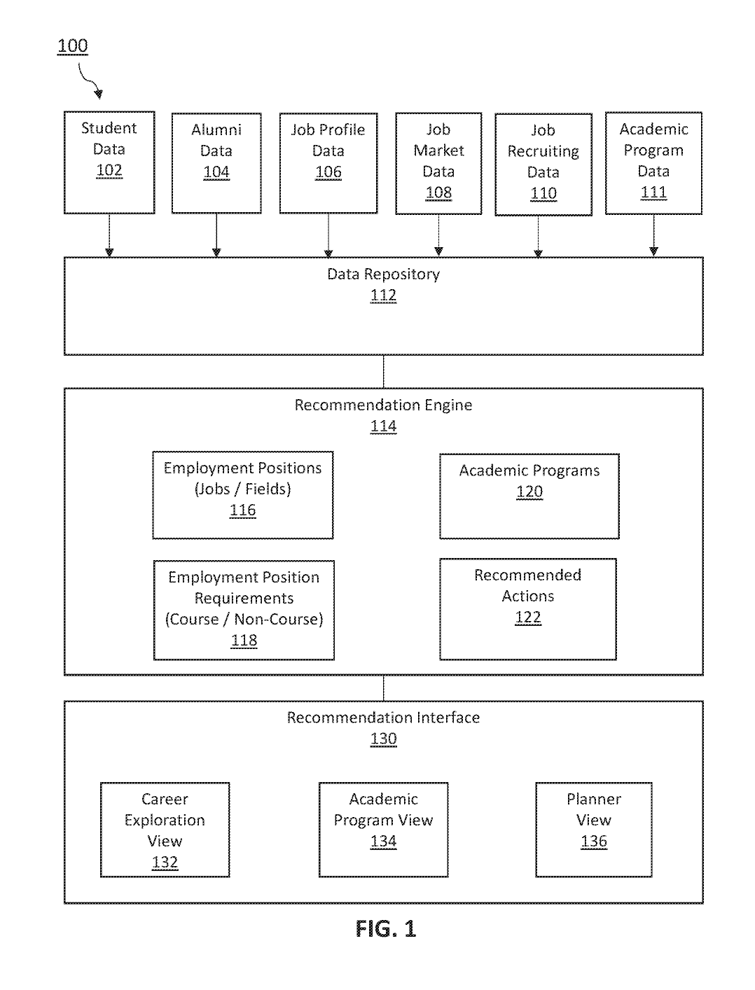

FIG. 1 illustrates a career guidance system 100 in accordance with one or more embodiments. As illustrated in FIG. 1, the system 100 includes an data repository 112, recommendation engine 114, and recommendation interface 130. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In some embodiments, the career guidance system 100 recommends employment positions 116 based on an academic program. Employment positions 116 may include jobs or job fields. A job is a specific role, such as paralegal or electrical engineer. A job may further be associated with a company and/or experience level. As an example, entry-level paralegal at Smith & Jones Law is a specific job opening. A job field may include a plurality of related jobs. As an example, nursing is a job field. The job field, nursing, includes the jobs emergency room nurse, hospice nurse, and pediatric nurse.

In some embodiments, the career guidance system 100 recommends academic programs 120 based on a target employment position. Academic programs 120 may include fields of study at higher education institutions. As an example, an academic program may be a major or minor, such as math, English, or chemistry. Alternatively, or additionally, an academic program may correspond to a degree program such as an Associate of Arts (A.A.), English program or a Master of Science (M.S.), biology program. As another example, an academic program may be a field of study for continuing education, such as a certificate program in software development or accounting.

In some embodiments, the data repository 112 is any type of storage unit and/or device (e.g., a file system, collection of tables, or any other storage mechanism) for storing data. Further, the data repository 112 may include multiple different storage units and/or devices. The multiple different storage units and/or devices may or may not be of the same type or located at the same physical site. Further, the data repository 112 may be implemented or may execute on the same computing system as the recommendation engine 114 and recommendation interface 130. Alternatively, or additionally, the data repository 112 may be implemented or executed on a computing system separate from the recommendation engine 114 and recommendation interface 130. The data repository 112 may be communicatively coupled to the recommendation engine 114 and recommendation interface 130 via a direct connection or via a network.

In an embodiment, the data repository 112 is populated with information from a variety of sources and/or systems. The data repository 112 may be populated with data such as student data 102, alumni data 104, job profile data 106, job market data 108, job recruiting data 110, and academic program data 111. The information may be structured (e.g. a table). Alternatively, or additionally, the information may be unstructured (e.g. text or social media posts).

In some embodiments, the student data 102 includes academic data, such as records from a student's prior and/or current educational institutions. The academic data may be collected by a university from the student. The academic data may be collected from the student's current or prior educational institutions. As an example, the data repository 112 may be connected with a records department of a university. The data repository may be populated with academic data from the records department. The academic data may include college records for a student such as courses completed and grades earned. The academic data may include academic records from other higher-learning institutions. The academic data may further include standardized test scores for the student. The academic data may include any information about a student's prior or current courses such as grades, enrollment status, class size, feedback, evaluations, attendance, professors, and participation scores.

In some embodiments, the student data 102 includes personal data. Personal data may include information about any activity performed by a student. As an example, personal data may include browser history indicating that a student has visited an employer's website. As another example, personal data may include information about the student winning first place in an engineering competition. As another example, personal data may include a social media post, made by the student, indicating an interest in architecture. As another example, personal data may include a set of interests obtained from a survey.

In some embodiments, the alumni data 104 includes information about graduates of an educational institution. The alumni data 104 may include academic programs which the alumni completed or in which the alumni were enrolled. The alumni data 104 may include courses which alumni completed. The alumni data 104 may include non-course experience associated with alumni, such as internships or sports. The alumni data 104 may include alumni employment information obtained from alumni surveys distributed by the educational institution. The alumni data 104 may include employers, job types, and salaries associated with alumni.

In some embodiments, job profile data 106 may include information about specific jobs. The job profile data 106 may include job requirements, such as bachelor's degree in nursing and one year's nursing experience. The job profile data 106 may include job information such as the day-to-day tasks associated with a job. The job profile data 106 may include the salary and benefits associated with a job. The job profile data 106 may be populated via the career services department of an educational institution. Alternatively, or additionally, the job profile data 106 may be populated via employer websites. Alternatively, or additionally, the job profile data 106 may be populated via job search websites.

In some embodiments, job market data 108 includes information about the demand for a type of job. The job market data may include a number of openings in a particular job field. As an example, four positions are available for petroleum engineers. The job market data 108 may include salary information across a job field. Job market data 108 may be obtained by aggregating and analyzing job profile data 106 for a plurality of jobs. Alternatively, or additionally, job market data 108 may be obtained from employers or job search websites.

In some embodiments, job recruiting data 110 is data about job applicants. The job recruiting data may include characteristics associated with successful, or unsuccessful, applicants for a particular job. The job recruiting data 110 may include information about employee performance at a particular job. The job recruiting data may be acquired from a human resources department of a company or from a human resources management application.

The data repository may further include academic program data 111. The academic program data 111 may include academic programs offered at an educational institution. The academic program data 111 may include academic program requirements for the respective academic programs. The academic program requirements may include course requirements needed to earn a particular degree. The academic program requirements may include non-course requirements associated with an academic program, such as a capstone program or internship.

In an embodiment, the recommendation engine 114 is hardware and/or software configured to identify employment positions and academic programs to recommend to a target student. The recommendation engine 114 may identify academic programs or employment positions for recommendation based on student information stored in the employment information repository 112.

In some embodiments, the recommendation engine 114 recommends an employment position or academic program based at least on employment position requirements 118. The employment position requirements 118 may include course requirements. As an example, the job, petroleum engineer, may require 10 units of petroleum engineering coursework. The employment position requirements 118 may include non-course requirements. Non-course requirements may include work experience such as internships or prior employment. Non-course requirements may include skills, such as typing or public speaking.

In some embodiments, the recommendation engine 114 determines a recommendation score for an academic program 120 with respect to a target student. The recommendation score may be a numerical value indicating whether the academic program should be recommended for the target student. As an example, the recommendation score may be a number from zero to one hundred. The recommendation score for an academic program may be computed based on a number of employees, with a target employment position, that completed the academic program. The recommendation score for an academic program may be further based on a number of remaining courses required for the student to complete the academic program. Additional factors may include an estimated time to employment for the student, employment-position salary, and student interests.

In some embodiments, the recommendation engine 114 determines a recommendation score for an employment position 116 with respect to a target student. The recommendation score may be a numerical value indicating whether the employment position 116 should be recommended for the target student. The system may compute the recommendation score for an employment position based on factors such as the number of employees that completed the student's current academic program and have the corresponding employment position. Additional factors that may be used to compute the recommendation score for an employment position include skills required for the employment position, the number of available positions, and the average salary.

The recommendation engine 114 may use one or more models to compute a recommendation score for a target student in relation to a particular academic program and/or employment position. Based on the recommendation score, the recommendation engine 114 selects academic programs and/or employment positions to recommend to the target. The recommendation engine may compare the recommendation score to a threshold value to determine whether to recommend the academic program or employment position. The system may organize the data into tabular form, classes, and/or categories, to enable data analysis via the model(s).

In some embodiments, the recommendation engine 114 may determine whether to recommend, or refrain from recommending, an academic program or employment position. The recommendation engine 114 determines whether to recommend a particular academic program or employment position based on the recommendation score for the particular academic program or employment position.

In some embodiments, the recommendation engine identifies recommended actions 122 for obtaining an employment position. The recommended actions 122 may include course requirements for the employment position. As an example, the system may recommend that a student take a course in C++ programming to pursue a career in computer programming. The recommended actions 122 may include non-course requirements for an employment position. As an example, the system may recommend that a student volunteer at a hospital to pursue a career in nursing. The recommended actions 122 may include actions that are useful for obtaining employment generally. As examples, the system may recommend that a student fill out a career survey or consult with a career advisor.

In an embodiment, the recommendation interface 130 is a Graphical User Interface (GUI) configured to display information about employment positions and academic programs. As an example, the recommendation interface 130 may display information to help the student choose an employment position, based on the student's experience and skills. The recommendation interface 130 may concurrently display information about multiple employment positions. Alternatively, or additionally, the recommendation interface 130 may display information about a set of academic programs which are recommended for obtaining a target employment position.

Different components of the recommendation interface 130 may be specified in different languages. The behavior of user interface elements may be specified in a dynamic programming language, such as JavaScript. The content of user interface elements may be specified in a markup language, such as hypertext markup language (HTML) or extensible markup language (XML) User Interface Language (XUL). The layout of user interface elements may be specified in a style sheet language, such as Cascading Style Sheets (CSS). Alternatively, the recommendation interface 130 may be specified in one or more other languages, such as Java, C, or C++.

The recommendation interface 130 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a mobile handset, a smartphone, a personal digital assistant (“PDA”), and/or a client device.

In an embodiment, the recommendation interface 130 includes, is triggered by, or is managed by a virtual assistant (not pictured). The virtual assistant presents information reactively (in response to a request for the information) or proactively (without a specific request for the information). The virtual assistant may periodically identify students that have not met with a career counselor to discuss employment goals. Alternatively, or additionally, the virtual assistant may periodically identify students that have not enrolled in an academic program. In response to identifying a student that should choose an academic program or employment position, the virtual assistant may present a notification. The virtual assistant may present the notification with a link to the recommendation interface 130 Alternatively, or additionally, the virtual assistant may directly present the list of recommended academic programs or employment positions.

3. Recommendation Interface

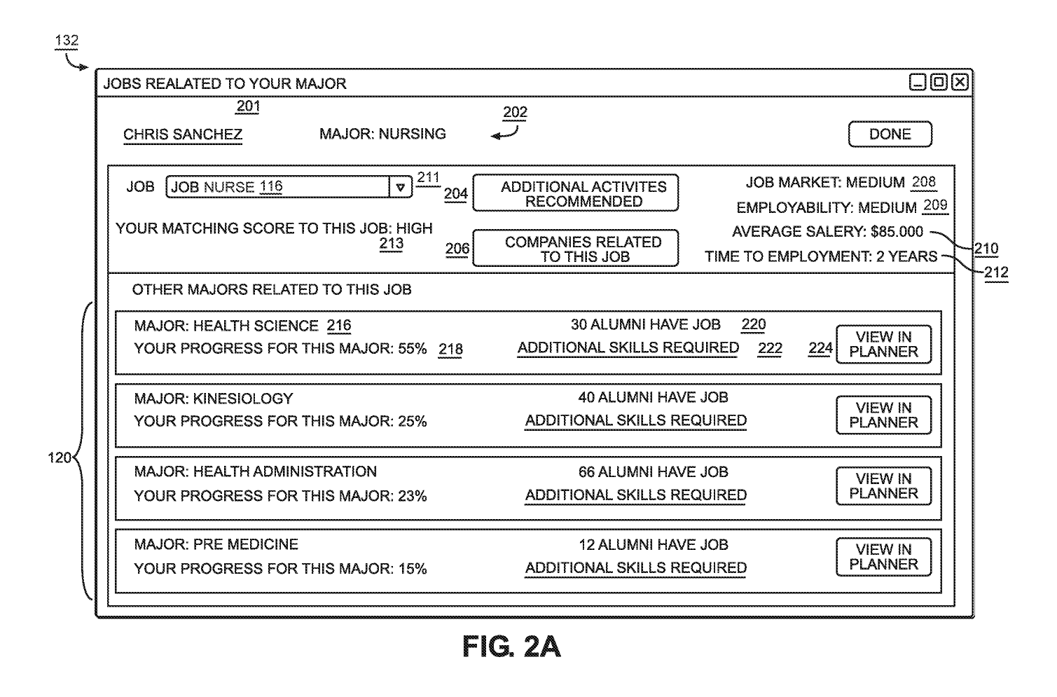

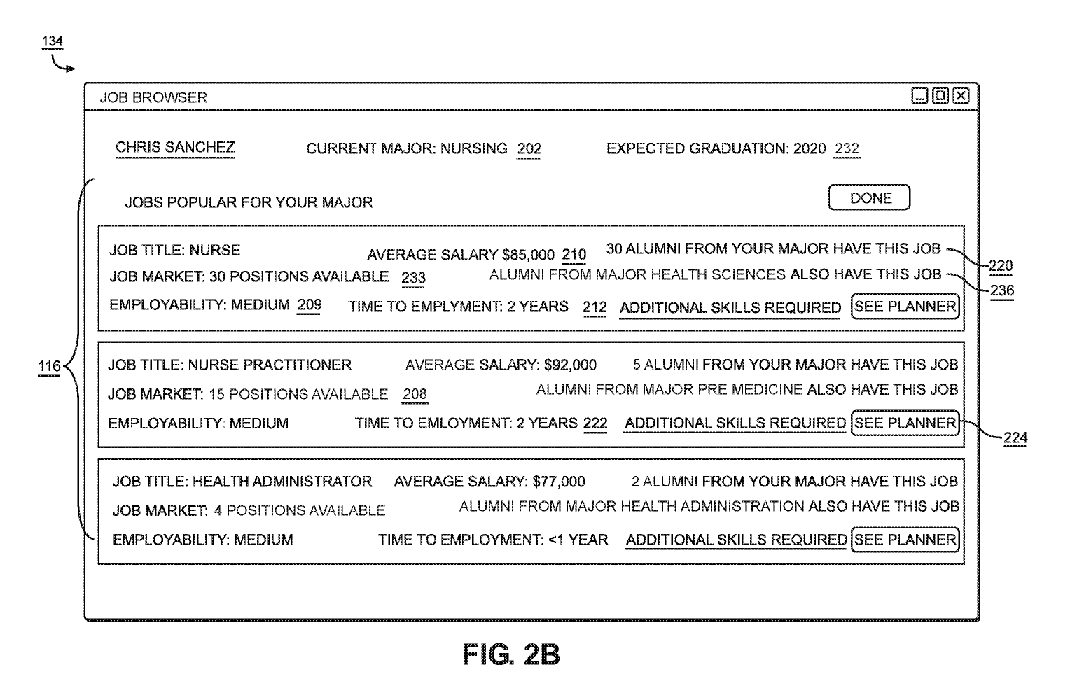

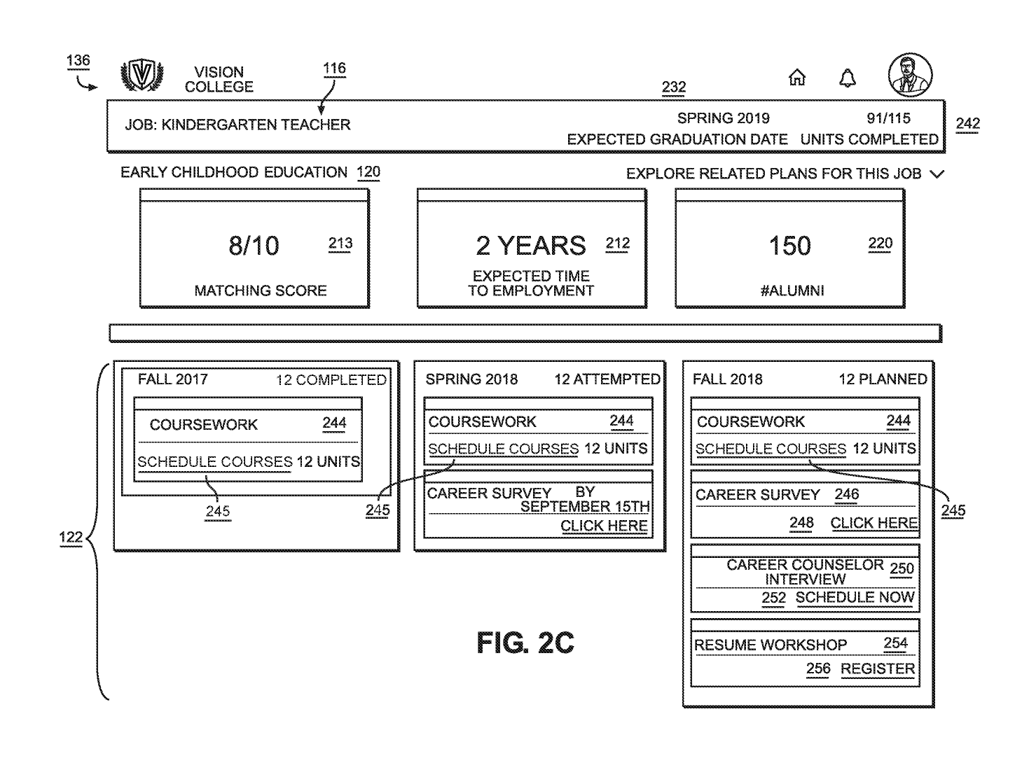

FIGS. 2A-2C illustrate examples of a recommendation interface 130 accordance with one or more embodiments. Operations described with respect to one component may instead be performed by another component. As illustrated in FIGS. 2A-2C, the recommendation interface 130 includes an academic program view 132, a career exploration view 134, and a planner view 136. The recommendation interface 130 may display information at various levels of granularity. The recommendation interface 130 may switch views, responsive to user input.

A. Academic Program View

An example of the academic program view 132 is shown in FIG. 2A. The academic program view 132 may include a list of academic programs 120 in relation to a particular employment position 116. The academic program view 132 is tailored to a particular student 201. The academic program view displays the student's name, Chris Sanchez. The academic program view further displays the student's current academic program 202, nursing.

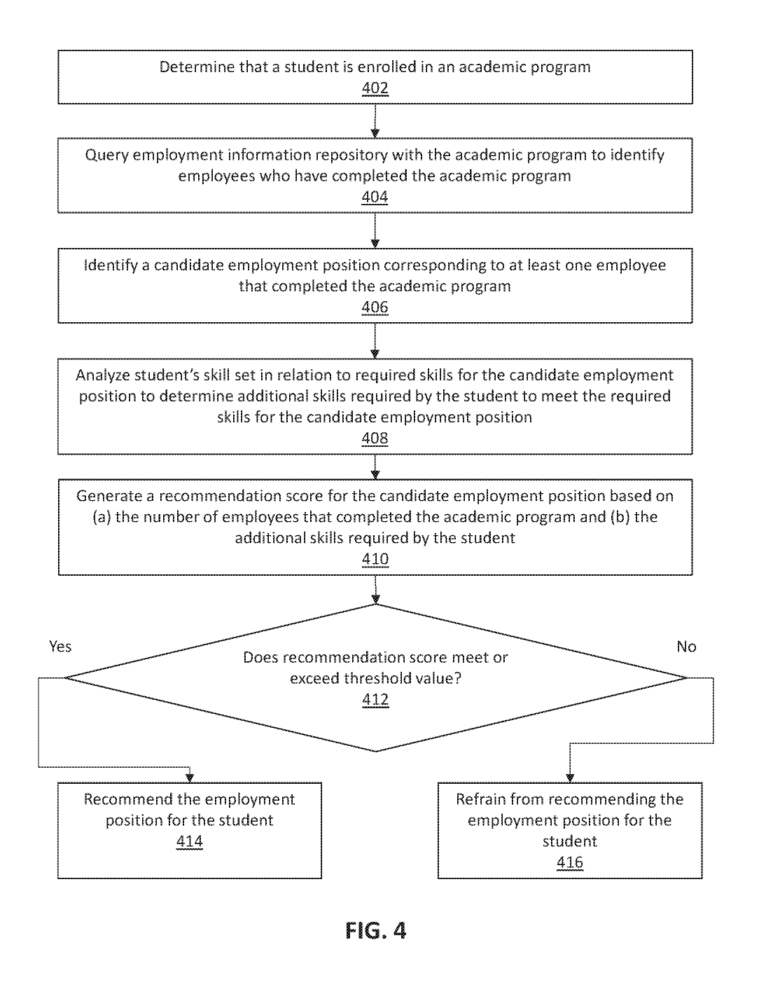

The academic program view 132 includes a drop-down menu 211 for selecting an employment position 116 and explore academic programs related to the selected employment position. The system receives user input from the student, via the drop-down menu, selecting the employment position Nurse. Responsive to the user's selection, the academic program view evaluates the student's major, Nursing in view of the position Nurse. The academic program view 132 may include a matching score 213 for the student and the selected employment position. A student's interests (e.g., extra-curricular activities, clubs, etc.), selected elective courses, and grades in specific courses related to the selected employment position may be used to compute whether the selected employment position is a good match for the student. The matching score may be qualitative (e.g., High, Medium, or Low). Alternatively, or additionally, e 111 the matching score may be quantitative (e.g., a value from zero to one hundred. As illustrated, Chris Sanchez has a High matching score to the Nurse employment position, indicating that the employment position is a good match for Chris. The recommendation engine may compute the matching score 213 substantially as described below with respect to the recommendation score for an employment position in FIG. 4.

For a particular selected employment position 116, the academic program view 132 may display information about each of a set of recommended academic programs 120 that are related to the employment position. This information allows a student to quickly identify all the academic paths (i.e., programs) to the selected employment position. In the illustrated example, the academic program view 132 displays the respective names of four majors related to nursing: health science, kinesiology, health administration, and pre-med.

The academic program view 132 includes the student's progress 218 in each respective academic program. Chris Sanchez has completed 55% of the requirements for the health science major and 25% of the requirements for the kinesiology major.

The academic program view 132 may display a number of alumni that completed the academic program and have the target employment position 116. The academic program view 132 shows that thirty alumni that graduated with health science degrees currently have employment positions as a nurse. The system may identify the number of alumni with a particular employment position based on alumni data 104 in the data repository.

The academic program view 132 may display a link or other interface element labeled “additional skills required” 222, in association with a recommended academic program. Responsive to detecting user interaction with the element 222, the system may display one or more additional skills, which are required for the employment position but not associated with the academic program. As an example, a health administration degree may teach many of the skills required for nursing, but not phlebotomy. Accordingly, the system identifies phlebotomy as an additional skill required. If the student were to pursue nursing via a health administration degree, the system would recommend taking additional coursework in phlebotomy.

The academic program view 132 may further include an interface element related to viewing a proposed course schedule for each academic program in a planner 224. Responsive to detecting user interaction with the planner element 224, the system may transition to the planner view 136 (described below with respect to FIG. 2C).

The academic program view 132 displays detailed information about the selected employment position. The academic program view 132 displays a job market rating 208 for the selected employment position 116. The system may assign qualitative or quantitative job market rating 208 to a particular employment position 116. The job market rating 208 may be computed based on data in the data repository 112. As an example, the system may assign a “high,” “medium,” or “low” job market rating 208, based on a number of job openings and/or average salary.

The academic program view 132 may include an employability rating 209 for the student. The system may assign a qualitative or quantitative employability rating 209 for a particular employment position and student pair. A student's education, experience, and skills may be used to determine the student's employability for the particular employment position. As an example, the system may assign a “high,” “medium,” or “low” employability rating 209, based on (a) a comparison of a student's completed coursework and requirements associated with an employment position and (b) a number of job openings associated with the employment position. The system may indicate how a different major affects the student's employability for the selected employment position. As an example, the system may display in relation to the health science major: “decreases employability for nurse position by 20%”. This indicates that if the student switched from majoring in nursing to health science, the student's employability for a nurse position decreases by 20%.

The academic program view 132 may include an average salary 210 for the selected employment position. As an example, the system displays an average salary of $85,000 for the employment position Nurse. The system may obtain the average salary for the selected employment position via the job market data 108 in the data repository 112.

The academic program view 132 may include an anticipated time to employment 212 for the student to obtain the selected employment position. As an example, the system displays a time to employment of 2 years for Chris Sanchez to be employed as a nurse. The system may compare the student's completed courses and other experiences to the requirements for the employment position. The system may further identify course and non-course offerings at the institution, to determine a time frame for the student to complete the requirements. Alternatively, or additionally, the system may determine that the student needs a particular degree for an employment position. The system may compute the time remaining for the student to complete the degree. Alternatively, or additionally, the time to employment may be based on an average time spent post-graduation seeking employment or building experience for the target employment position.

The academic program view 132 may include an interface element 204 associated with recommended actions 124. Responsive to detecting user interaction with the interface element 204, the system may display a list of identified recommended actions 124. As an example, the system may display a modal listing: “volunteer at hospital,” “complete Nursing 301,” and “complete Nursing program.”

The academic program view 132 may display an interface element 206 labeled “companies related to this job.” Responsive to detecting user interaction with interface element 206, the system may display information about companies that have, or tend to have, openings related to the selected employment position. As an example, the system displays a modal listing companies that are hiring nurses. Alternatively, or additionally, the system may display current employment position openings. As an example, the system displays a modal comprising links to several postings for nursing positions.

B. Career Exploration View

An example of the career exploration view 134 is shown in FIG. 2B. The career exploration view 134 includes a list of candidate employment positions 116 for a student 201. The employment positions are selected for display based on the student's current academic program 202.

In the illustrated example, the system displays Chris's current academic program 202, nursing. The system further displays Chris's expected graduation year 232, 2020. The career exploration view 134 includes a list of employment positions 116 associated with the student's current academic program. In the illustrated example, the list of employment positions 116 is labeled “jobs popular for your major.” The employment position titles listed are nurse, nurse practitioner, and health administrator. The recommended employment positions may be determined based on popularity with graduates of the student's academic program. As an example, the system determines that thirty alumni of the nursing program are nurses, five alumni from the nursing program are nurse practitioners, and two alumni from the nursing program are health administrators. The system determines that nurse, nurse practitioner, and health administrator are the most popular employment positions for nursing alumni. Accordingly, the career exploration view 134 includes the three most popular employment positions for nursing alumni: nurse, nurse practitioner, and health administrator. Selecting a set of recommended employment positions is described below in detail with respect to FIG. 4.

The career exploration view 134 may include a number of positions available 233. The interface indicates that thirty positions are available for nurse and fifteen positions are available for nurse practitioner. The number of available positions 233 may be determined based on job market data in the data repository.

The career exploration view 134 may further include an employability rating 209, average salary 210, and time to employment 212, as described above with respect to FIG. 2A. The career exploration view 134 may further include a number of alumni with the employment position 220 as described above with respect to FIG. 2A.

The career exploration view 134 may include one or more additional academic programs associated with a particular employment position. As an example, the interface displays information about the employment position nurse practitioner, including “alumni from major pre-medicine also have this employment position.” The additional programs may be identified based on alumni data in the data repository 112.

The career exploration view 134 may further include interface elements corresponding to additional skills required 222 and planning 224, as described above with respect to FIG. 2A. In response to user activation of a button or link labeled “See in Planner” 224, the recommendation interface may transition to a planner view 136.

C. Planner View

An example of a planner view 136 is shown in FIG. 2C. The planner view 136 may include detailed information about recommended actions 122 for a student.

The planner view 136 includes a target employment position 116 and an academic program 120 associated with the target student. Based on the target employment position 116 and academic program 120, detailed information is displayed.

The planner view 136 includes a matching score 213 and expected time to employment 212, as described above with respect to FIG. 2A. The planner view 135 further includes an expected graduation date 232 as described above with respect to FIG. 2B.

The planner view 136 includes the student's units completed for the academic program 120. The target student has completed 91 units, out of the total 115 units required for a degree in early childhood education. The system may determine the units completed by comparing the student's academic records with the requirements of the academic program. Alternatively, or additionally, the planner view 136 may include the number of units to-be-completed by the student (e.g., 115−91=24 units).

The planner view 136 includes recommended actions 122, organized by semester. The recommended actions may include recommended coursework 244, as well as activities organized by the career services office of the educational institution.

The planner view 136 includes overview information about required coursework 244, organized by semester. The student already completed twelve units required for Early Childhood Education in the Fall 2017 semester. The student is currently attempting twelve units required for Early Childhood Education in the Spring 2018 semester. The student has twelve units required for Early Childhood Education planned in the Fall 2018 semester.

The planner view 136 includes a scheduling element 245 labeled “schedule classes.” The scheduling element comprises a link to a module that organizes and presents the coursework still to be completed by the student for completion of the academic program. The module may be an event management interface. An event management interface may enable scheduling classes within an academic term and or planning courses across multiple academic terms. Generating and displaying an event management interface is described detail in U.S. Nonprovisional patent application Ser. No. 15/933,294, Event Management System, incorporated by reference herein.

The planner view 136 includes a career survey 246 as a recommended action for two semesters. A career survey 246 may collect information about a student's career interests and/or job experience. The planner view 136 includes a link 248 for completing a career survey.

The planner view 136 includes a career counselor interview 250 as a recommended action for one semester. The system recommends that the student meets with a career counselor to discuss employment plans and recommended actions. The planner view 136 includes a link 252 to facilitate scheduling a career counselor interview.

The planner view 136 includes a resume workshop 254 as a recommended action for one semester. The system recommends that the student attends a resume workshop to improve resume-writing skills. The planner view 136 includes a link 256 to facilitate registering for the resume workshop

4. Recommending an Academic Program for a Target Student Based on a Target Employment Position

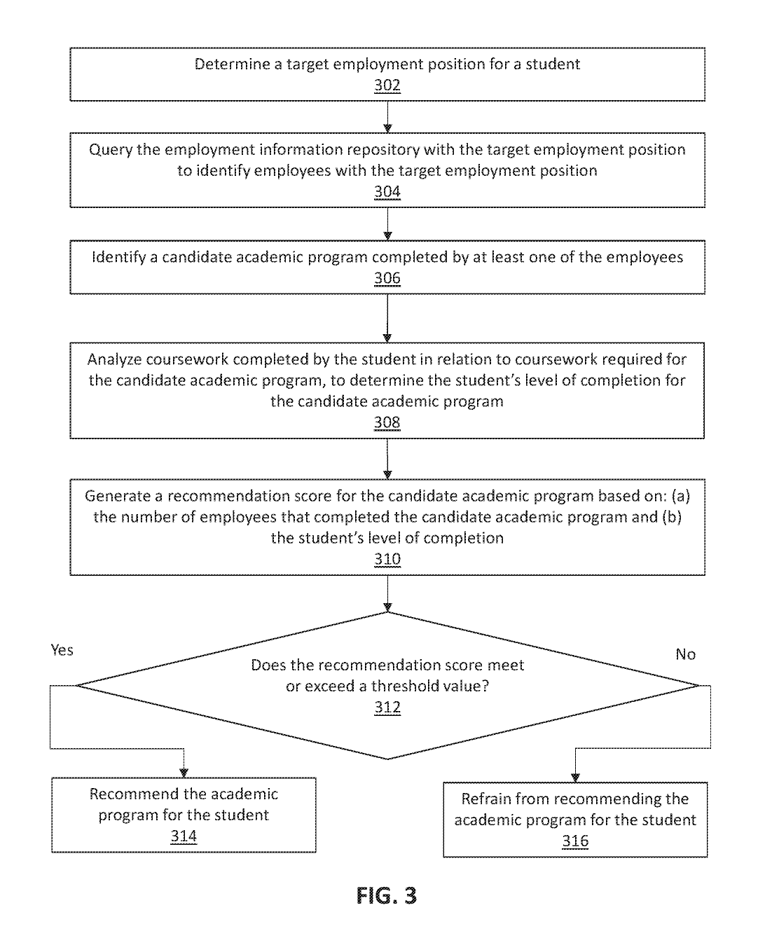

FIG. 3 illustrates an example set of operations for recommending an academic program for a student based on a target employment position in accordance with one or more embodiments. One or more operations illustrated in FIG. 3 may be modified, rearranged, or omitted altogether. Accordingly, the particular sequence of operations illustrated in FIG. 3 should not be construed as limiting the scope of one or more embodiments.

In some embodiments, the recommendation engine determines a target employment position for a student (Operation 302). The recommendation engine may determine the target employment position based on user input. As an example, a student or counselor may select a target employment position from a drop-down menu on the recommendation interface. Alternatively, or additionally, the system may select the target employment position. As an example, the system may select a target employment position based on popularity with alumni of the student's current academic program.

In some embodiments, the recommendation engine queries the data repository with the target employment position to identify employees with the target employment position (Operation 304). As an example, the target employment position is author. The recommendation engine queries the data repository to identify a set of employees that are authors. The recommendation engine may identify the employees based on specific jobs, such as entry-level electrical engineer. Alternatively, or additionally, the recommendation engine may identify the employees based on job fields, such as engineering.

In some embodiments, the recommendation engine identifies a candidate academic program completed by at least one of the employees (Operation 306). The recommendation engine may identify academic programs completed by employees by querying the data repository. As an example, based on alumni data, the system may determine that several alumni of the institution are currently employed as doctors and earned a degree in biology. As another example, based on job recruiting data, the system may determine that thirty-two employees of E-Corp are software engineers and majored in computer science.

In some embodiments, the recommendation engine analyzes coursework completed by the student in relation to coursework required for the candidate academic program to determine the student's level of completion for the candidate academic program (Operation 308). The recommendation engine may identify student data for the student in the data repository to determine coursework completed by the student. The recommendation engine may identify requirements for the candidate academic program based on academic program data in the data repository.

The recommendation engine may compare the identified completed coursework to the identified academic program requirements. As an example, the system may determine that John Smith has completed 55% of the coursework required for the sociology major and 40% of the coursework required for the psychology major. The system may further determine a period of time estimated for completing the remaining requirements for an academic program. For example, John Smith needs to take nine particular courses to complete the requirements for the sociology major. The system identifies offerings of the nine courses. Based on the offerings and a maximum course load per semester, the system determines that John can complete the requirements for the sociology major in three semesters.

In some embodiments, the recommendation engine generates a recommendation score for the candidate academic program based on: (a) the number of employees that completed the candidate academic program and (b) the student's level of completion (Operation 310).

The recommendation engine may use the number of employees that completed the candidate academic program to generate a mathematical model yielding the recommendation score. As an example, for each employee with the target employment position that completed a communications degree program, the student's recommendation score for the communications degree program is incremented by five. Alternatively, or additionally, the recommendation engine may base the recommendation score on whether the academic program has been completed by a minimum threshold number of employees with the target employment position. As an example, the recommendation score is calculated based on a delta function. The delta function is equal to zero if two or fewer employees with the target employment position completed the corresponding academic program. The delta function is equal to one if three or more employees with the target employment position completed the corresponding academic program.

The recommendation engine may further base the mathematical model on the student's level of completion in the academic program. As an example, the system may increment or decrement the recommendation score based on the percentage of the requirements completed. As another example, the system may increment or decrement the recommendation score based on a projected amount of time that the student would require to complete the academic program. The system may assign a comparatively high recommendation score for a program in which the student has one year remaining. The system may assign a comparatively low recommendation score for an academic program in which the student has two years remaining.

Alternatively, or additionally, the recommendation engine may base the recommendation score on a comparison of characteristics of the student and characteristics of the employees with the target employment position. The recommendation engine may weight specific characteristics that the student shares with a set of employees with the target employment position. Attributes more strongly correlated with having the employment position may be weighted more heavily than other attributes. As an example, the recommendation engine determines that courses completed by a student and the student's Grade Point Average (GPA) have a strong correlation with being employed as a psychiatrist. Extracurricular activities associated with the student and student interests have a weak correlation with being employed as a psychiatrist. Accordingly, the recommendation engine weights courses completed at the institution and GPA more heavily than extracurricular activities and student interests, for the recommendation score computation.

In some embodiments, the recommendation engine updates the model for computing recommendation scores based on refreshed data. As an example, the recommendation engine may update the model based on the student's subsequent employment. Subsequent to recommending an academic program for the student, the system may determine that the target student obtained employment as a journalist. The system may increment a recommendation score, for the academic program, for another student interested in journalism.

In some embodiments the recommendation engine determines whether the recommendation score meets or exceeds a threshold value (Operation 312). The recommendation engine may identify a stored threshold value. The recommendation engine compares the recommendation score to the threshold value.

In some embodiments, if the recommendation score meets or exceeds the threshold value, then the recommendation engine recommends the academic program for the student (Operation 314). The system may identify a predetermined threshold value for comparison to the computed recommendation score. The system may recommend the academic program to a student or counselor via the academic program view of the recommendation interface, as described in detail with respect to FIG. 2A. Alternatively, or additionally, the system may display recommended programs via a virtual assistant. Alternatively, or additionally, the system may recommend academic programs by transmitting a notification, such as email, text message, or voice message.

The system may concurrently display a set of academic programs. Each of the set of academic programs may be identified as described above with respect to operations 302-314. The system may select the set of academic programs based on the recommendation scores exceeding the threshold value. Alternatively, or additionally, the system may select a particular number of academic programs to display. As an example, the system may display the three academic programs with the highest recommendation scores.

The system may display a list of candidate academic programs. The system may concurrently display the student's level of completion for each academic program of the set of candidate academic programs. As an example, the recommendation interface displays four recommended academic programs for a student, with respective completion percentages: nursing (55%), health sciences (49%), biology (31%), and health management (30%). The system may display the list of the recommended academic programs in a ranked order based on the student's level of completion for each academic program.

The system may further display additional information for each of the recommended academic programs. The system may display an amount of time for completion (e.g., two years). The system may display an estimated cost for completion (e.g., $36,000). The system may display a number of remaining courses required for completion (e.g. four courses). The system may display a number of remaining credits required for completion (e.g., fourteen semester units).

In some embodiments, if the recommendation score does not meet or exceed the threshold value, then the recommendation engine refrains from recommending the academic program for the student (Operation 316). The system may refrain from displaying any academic programs which are not recommended for the target student.

In some embodiments, the system may display one or more recommended actions corresponding to a target employment position. The recommended actions may be determined by comparing the student's completed coursework to coursework required for an employment position. Alternatively, or additionally, the recommended actions may be determined by comparing the student's skills to skills required for an employment position (as described below with respect to Operation 408). Alternatively, or additionally, certain actions may be recommended generally for students. As an example, the system may recommend that students meet with a career counselor in the sophomore year. As other examples, the system may recommend that a student complete a career survey or a resume workshop. The system may recommend courses to current or former students. As an example of the latter, Mary Jones graduates with a nursing degree. Mary seeks a specialized nursing position. Accordingly, the system recommends that Mary take a continuing education course in the specialized field. The system may recommend non-course requirements for students. As examples, the system may recommend internships, tests, or certifications for students.

The following detailed example illustrates operations in accordance with one or more embodiments. The following detailed example should not be construed as limiting the scope of any of the claims. A student, Chris Sanchez, logs into the academic program view of the recommendation interface, as illustrated in FIG. 2A. The academic program view includes a drop-down menu for selecting a target employment position. Chris selects a desired employment position, nurse. Responsive to detecting selection of the target employment position, the system identifies the target employment position for analysis.

The recommendation engine queries the data repository with the target employment position, nurse. The recommendation engine identifies a set of two hundred employees that are nurses.

The recommendation engine identifies a set of five academic programs (other than Chris's current program, nursing) which were completed by at least ten of the employees that are nurses. The set of five academic programs is: health science, kinesiology, health administration, biology, and pre-medicine.

The recommendation engine analyzes coursework completed by Chris. The recommendation engine compares Chris's completed coursework to the coursework required to complete each of the five identified academic programs. Chris has completed 55% of the required courses for the health science major. Chris has completed 25% of the required courses for the kinesiology major. Chris has completed 23 of the required courses for the health administration major. Chris has completed 15% of the required courses for the pre-medicine major. Chris has completed 17% of the required courses for the biology major.

The recommendation engine generates a recommendation score for each of the five candidate academic programs. The recommendation score for each candidate academic program is equal to

$${R}_{AP} = ( \frac{{N}_{E} + {P}_{C}}{10} ) \times \frac{S}{10 \text{,} 000} ,$$

where R_{AP} is the recommendation score for an academic program, N_{E} is the number of employees with the target position that completed the academic program, and P_{C} is the percent completion for Chris in the academic program. S is the average salary for graduates of the academic program.

For health science, N_{E}=30, P_{C}=55, and S=$80,000. The recommendation score for health science is R_{AP}=68. For kinesiology, N_{E}=40, P_{C}=25, and S=$50,000. The recommendation score for kinesiology is R_{AP}=32.5. For health administration, N_{E}=66, P_{C}=23, and S=$65,000. The recommendation score for health administration is R_{AP}=57.85. For biology, N_{E}=11, P_{C}=17, and S=$55,000. The recommendation score for biology is R_{AP}=15.4. For pre-medicine, N_{E}=12, P_{C}=15, and S=$200,000. The recommendation score for pre-medicine is R_{AP}=54.

The recommendation engine identifies a threshold score for recommending an academic program. A threshold value of 25 is stored for recommending an academic program. The system compares the five computed recommendation scores to the threshold value. For health science, the recommendation score of 68 exceeds the threshold value of 25. For kinesiology, the recommendation score of 32.5 exceeds the threshold value of 25. For health administration, the recommendation score of 57.85 exceeds the threshold value of 25. For biology, the recommendation score of 15.8 does not meet or exceed the threshold value of 25. For pre-medicine, the recommendation score of 54 exceeds the threshold value of 25.

The system recommends the academic programs for Chris which have recommendation scores exceeding the threshold value. The recommended academic programs are health science, kinesiology, health administration, and pre-medicine. The system refrains from recommending the academic program which does not have a recommendation score exceeding the threshold value. The system does not recommend biology.

The system displays the four recommended academic programs—health science, kinesiology, health administration, and pre-medicine. Each recommended academic program is displayed, via the academic program view of the recommendation interface, with Chris's progress in the academic program and the number of identified nurses that completed the academic program.

5. Recommending an Employment Position for a Student

FIG. 4 illustrates an example set of operations for recommending an employment position for a student in accordance with one or more embodiments. One or more operations illustrated in FIG. 4 may be modified, rearranged, or omitted altogether. Accordingly, the particular sequence of operations illustrated in FIG. 4 should not be construed as limiting the scope of one or more embodiments.

In some embodiments, the recommendation engine determines that a student is enrolled in an academic program (Operation 402). The recommendation engine may determine whether a student is enrolled in an academic program by querying the data repository. Alternatively, or additionally, the recommendation engine may identify an academic program in which a student is enrolled based on user input to the recommendation interface. As an example, a student user selects a major from a drop-down menu.

In some embodiments, the recommendation engine queries the data repository with the academic program to identify employees who have completed the academic program (Operation 404). As an example, the academic program is a degree program for a Bachelor of Science (BS) in chemistry. The recommendation engine queries the data repository to identify a set of employees that completed the chemistry BS program.

In some embodiments, the recommendation engine identifies a candidate employment position corresponding to at least one employee that completed the academic program (Operation 406). The recommendation engine may identify a candidate employment position by querying the data repository. As an example, the system may query the data repository to identify employees that completed a particular academic program, such as nursing. The system may sort the employees that completed the nursing program by available job information. The system may determine that a number, e.g., ten, alumni of the nursing program are employed as nurses.

In some embodiments, the recommendation engine analyzes the student's skill set in relation to required skills for the candidate employment position to determine additional skills required by the student to meet the required skills for the candidate employment position (Operation 408).

The recommendation engine may identify student data for the student in the data repository to determine the student's skill set. Student skills may be determined based on courses completed by a student. As an example, students that completed a word processing class are deemed to have a typing skill. Alternatively, or additionally, student skills may be determined based on non-course experience. As an example, students enrolled in team sports are deemed to have a teamwork skill.

The recommendation engine may identify required skills for the candidate employment position by querying the data repository. As an example, job profile data compiled from job postings may show that nursing jobs require medical skills and interpersonal skills.

The recommendation engine may compare the identified student skills to the identified required skills. As an example, the recommendation engine determines that the required skills for a laboratory manager are laboratory techniques, occupational safety, and leadership. The recommendation engine determines that Jane Kim has acquired skills in laboratory techniques and leadership. Accordingly, the recommendation engine determines that Jane Kim has two of the three skills required for a laboratory manager position. The recommendation engine determines an additional skill required by Jane to satisfy the requirements of the laboratory manager position: occupational safety.

In some embodiments, the recommendation engine generates a recommendation score for the candidate employment position based on (a) the number of employees that completed the academic program and (b) the additional skills required by the student (Operation 410). The recommendation engine may generate a mathematical model yielding the recommendation score, based on the number of employees that completed the academic program and the additional skills required. As an example, for each employee with a job as an attorney that completed a political science degree program, the student's recommendation score for the political science program is incremented by one. For each additional skill required by the student, the student's recommendation score is decremented by 0.3.

Alternatively, or additionally, the recommendation engine may base the recommendation score for an employment position on whether the employment position corresponds to a minimum threshold number of employees who have completed the academic program in which the student is enrolled. As an example, the recommendation score is calculated based on a delta function. The delta function is equal to zero if four or fewer employees with the employment position completed the academic program in which the student is enrolled. The delta function is equal to one if five or more employees with the employment position completed the academic program in which the student is enrolled.

Alternatively, or additionally, the recommendation engine may base the recommendation score on a comparison of characteristics of the student and characteristics of the employees with the target employment position, as described above with respect to FIG. 3.

In some embodiments, the recommendation engine determines whether the recommendation score meets or exceeds a threshold value (Operation 412). The recommendation engine may identify a stored threshold value. The recommendation engine compares the recommendation score to the threshold value.

In some embodiments, if the recommendation score meets or exceeds the threshold value, then the recommendation engine recommends the employment position for the student (Operation 414). The system may recommend the employment position to a student or counselor via the career exploration view of the recommendation interface, as described in detail with respect to FIG. 2B. Alternatively, or additionally, the system may display a recommended employment position via a virtual assistant. Alternatively, or additionally, the system may recommend an employment position by transmitting a notification, such as email, text message, or voice message.

The system may concurrently recommend a set of employment positions. Each of the set of employment positions may be identified as described above with respect to operations 402-414. The system may display a list of recommended employment positions. The system may concurrently display information corresponding to each of the employment positions of the set of recommended employment positions. As an example, the system may display, for each recommended employment position, the set of additional skills required by the student to meet the required skills for each particular employment position. The system may display a list of the recommended academic programs in a ranked order. The ranked order may, for example, be based on the number of employees that have completed the academic program in which the student is enrolled.

Alternatively, or additionally, the displayed information corresponding to each of the employment positions may include one or more of: an average salary for the employment position, job market information for the employment position, or an employability rating associated with the particular position.

In some embodiments, if the recommendation score does not meet or exceed the threshold value, then the recommendation engine refrains from recommending the employment position for the student (Operation 416). The system may refrain from displaying any employment positions which are not recommended for the target student.

The following detailed example illustrates operations in accordance with one or more embodiments. The following detailed example should not be construed as limiting the scope of any of the claims. A student, Chris Sanchez, logs into the career exploration view of the recommendation interface, which is similar to the example in FIG. 2B.

The system identifies Chris's current academic program by querying the student data in the data repository. The system determines that Chris is currently enrolled in the nursing program.

The recommendation engine queries the data repository with the academic program, nursing. The recommendation engine identifies a set of fifty alumni that completed the nursing program.

The recommendation engine identifies a set of four employment positions which were completed by at least one of the alumni that completed the nursing program. The set of four employment positions is: nurse, nurse practitioner, health administrator, and teacher.

The recommendation engine analyzes Chris's skill set. The recommendation engine identifies several skills attained by Chris, including communication skills, laboratory skills, and clinical skills. The recommendation engine identifies skills required for each of the five candidate employment positions. Nursing requires communication skills, laboratory skills, clinical skills, and ethics skills. The nurse practitioner position requires communication skills, laboratory skills, clinical skills, ethics skills, and diagnostic skills. The health administrator position requires communication skills, clinical skills, and business skills. The teacher position requires communication, organization, and mentoring skills.

The recommendation engine compares Chris's skills to the skills required for each of the employment positions. The recommendation engine determines the additional skills required by Chris for each of the employment positions. For the nurse position, Chris requires one skill, ethics. For the nurse practitioner position, Chris requires two skills, ethics and diagnostic skills. For the health administrator position, Chris requires one skill, business skills. For the teacher position, Chris requires two skills, organization and mentoring.

The recommendation engine generates a recommendation score for each of the four candidate employment positions. The recommendation score for each candidate employment is equal to

R_{EP}=N_{E}+N_{A}−S_{R},

where R_{EP} is the recommendation score for the employment position, N_{E} is the number of employees with the target position that completed the nursing program, N_{A} is the number of available positions identified for the employment position, and S_{R} is the number of skills that Chris still requires for the employment position.

For the nurse position, N_{E}=30, N_{A}=30, and S_{R}=1. The recommendation score for the nurse position is R_{EP}=59. For the nurse practitioner position, N_{E}=5, N_{A}=15, and S_{R}=2. The recommendation score for the nurse practitioner position is R_{EP}=18. For the health administrator position, N_{E}=2, N_{A}=4, and S_{R}=1. The recommendation score for the health administrator position is R_{EP}=5. For the teacher position, N_{E}=1, N_{A}=5, and S_{R}=2. The recommendation score for the teacher position is R_{EP}=4.

The recommendation engine identifies a threshold score for recommending an employment position. A threshold value of five is stored for recommending an employment position. The system compares the four computed recommendation scores to the threshold value. For the nurse position, the recommendation score of 59 exceeds the threshold value of 5. For nurse practitioner, the recommendation score of 18 exceeds the threshold value of 5. For health administrator, the recommendation score of 5 equals the threshold value of 5. For teacher, the recommendation score of 4 does not meet or exceed the threshold value of 5.

The system recommends the academic programs for Chris which have recommendation scores which meet or exceed the threshold value. The recommended employment positions are nurse, nurse practitioner, and health administrator. The system refrains from recommending the employment position which does not have a recommendation score exceeding the threshold value. The system does not recommend teacher.

The system displays the three recommended employment positions—nurse, nurse practitioner, and health administrator. Each recommended employment position is displayed with information corresponding to the respective employment position. The displayed information includes the computed recommendation score for each displayed employment position. The displayed information further includes the average salary for the respective employment position, the number of alumni of the nursing program with the respective employment position, the number of positions available, and an estimated time to employment for Chris. The system further displays an interface element for displaying a modal listing the required skills Chris needs to be eligible for each of the displayed employment positions.

6. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

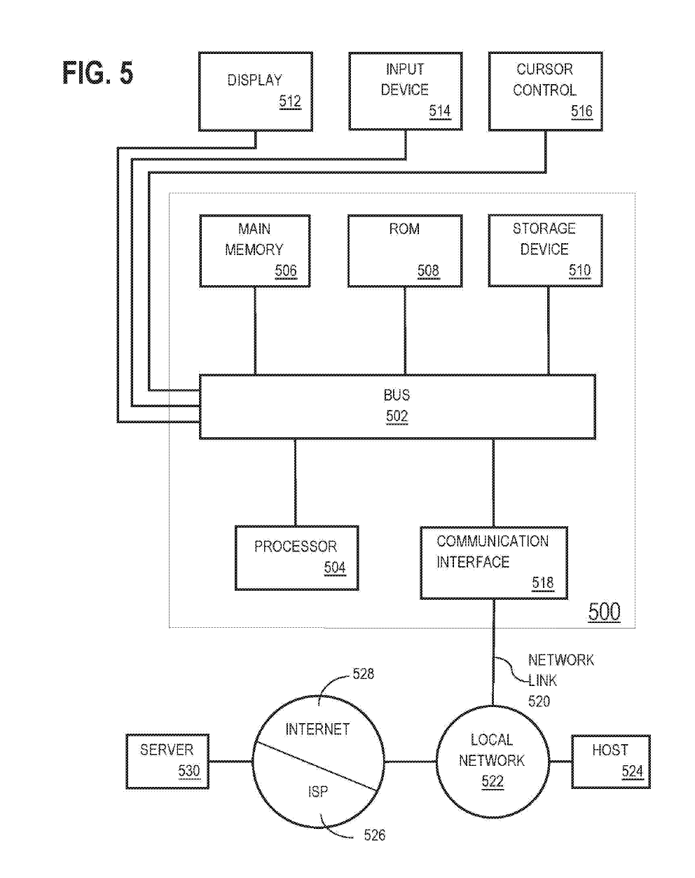

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general-purpose microprocessor.

Computer system 500 also includes a main memory 506, such as a random-access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated-services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A non-transitory computer readable medium comprising instructions which, when executed by one or more hardware processors, causes performance of operations comprising:
determining a target employment position for a student;
querying an employment database with the target employment position to identify a plurality of employees with the target employment position;
selecting academic programs, completed by at least one of the plurality of employees with the target employment position, as a set of candidate academic programs for the student;
analyzing coursework completed by the student in relation to coursework required for each academic program of the set of candidate academic programs to determine a level of completion, corresponding to the student, for each academic program of the set of candidate academic programs completed by at least one of the plurality of employees with the target employment position;
concurrently displaying the student's level of completion for each academic program of the set of candidate academic programs completed by at least one of the plurality of employees with the target employment position.

2. The medium of claim 1, wherein the operations further comprise displaying a composite interface element for each of the set of candidate academic programs completed by at least one of the plurality of employees with the target employment position, wherein the composite interface element comprises one or more of: an element for planning or an element for scheduling.

3. The medium of claim 1, wherein the operations further comprise displaying, for each academic program of the set of candidate academic programs, at least one of: an amount of time for completion, an estimated cost for completion, a number of courses for completion, or a number of credits for completion.

4. The medium of claim 1, wherein the displaying operation comprises listing the set of candidate academic programs in a ranked order based on the student's level of completion for each candidate program of the set of candidate academic programs.

5. The medium of claim 1, wherein selecting the academic programs as the set of candidate academic programs for the student is further responsive to determining that each of the set of candidate academic programs has been completed by a minimum threshold number of employees with the target employment position.

6. The medium of claim 1, wherein the operations further comprise:
determining a target set of skills comprising skills associated with at least one of the plurality of employees with the target employment position, wherein the target set of skills are different from the coursework required for any of the set of candidate academic programs;
analyzing the student's skills in relation to target set of skills to determine one or more of the target set of skills that the student does not possess;
displaying the one or more of the target set of skills, associated with at least one of the plurality of employees with the target employment position, that the student does not possess.

7. The medium of claim 1, wherein the operations further comprise:
concurrently displaying a respective link, for each particular academic program of the set of candidate academic programs, to a planning module that organizes and presents the coursework still to be completed by the student for completion of the particular academic program.

8. The medium of claim 1, wherein selecting the academic programs as the set of candidate academic programs for the student comprises:
determining a recommendation score for each academic program of a plurality of academic programs based at least on the student's level of completion for each academic program of the plurality of academic programs;
wherein the academic programs are selected in the set of candidate academic programs based on the respective recommendation score being above a threshold value.

9. The medium of claim 1, wherein the operations further comprise displaying one or more recommended actions corresponding to the target employment position, the recommended actions comprising one or more of: completing course requirements for the target employment position, completing non-course requirements for the target employment position, completing a career survey, completing a career counselor meeting, and completing a resume workshop.

10. The medium of claim 1, wherein the academic programs comprise one or more of: majors, certificate programs, minors, or degree programs.

11. A non-transitory computer readable medium comprising instructions which, when executed by one or more hardware processors, causes performance of operations comprising:
determining that a student is enrolled in a particular academic program;
querying an employment database with the particular academic program to identify a plurality of employees who have completed the particular academic program;
selecting employment positions, corresponding at least one of the plurality of employees who have completed the particular academic program, as a set of candidate employment positions for the student;
analyzing a skill set, corresponding to the student, in relation to required skills for each employment position of the set of candidate employment positions, to determine a set of additional skills required by the student to meet the required skills for each candidate employment position of the set of candidate employment positions;
concurrently displaying information corresponding to each of the employment positions of the set of candidate employment positions, the respective information for each particular employment position of the set of candidate employment positions comprising the set of additional skills required by the student to meet the required skills for each particular employment position.

12. The medium of claim 11, wherein the respective information for each particular employment position further comprises, for each particular employment position, at least one of: an average salary for the particular employment position, job market information for the particular employment position, or an employability rating associated with the particular employment position.

13. The medium of claim 11, wherein the displaying operation comprises listing the set of candidate employment positions in a ranked order based on a number of employees that have completed the particular academic program.

14. The medium of claim 11, wherein selecting the employment positions as the set of candidate employment positions for the student is further responsive to determining that each of the set of candidate employment positions correspond to a minimum threshold number of employees who have completed the particular academic program.

15. The medium of claim 11, wherein the operations further comprise:
concurrently displaying a respective link, for each particular employment position of the set of candidate employment positions, to a planning module that organizes and presents coursework still to be completed by the student for completion of the particular academic program.

16. The medium of claim 11, wherein selecting the employment positions as the set of candidate employment positions for the student comprises:
determining a recommendation score for each employment position of a plurality of employment positions based at least on the student's skill set in relation to the required skills for each employment position;
wherein the employment positions are selected in the set of candidate employment positions based on the respective recommendation score being above a threshold value.

17. The medium of claim 11, wherein the operations further comprise displaying one or more recommended actions corresponding to a particular employment position, the recommended actions comprising one or more of: completing course requirements for the particular employment position, completing non-course requirements for the particular employment position, completing a career survey, completing a career counselor meeting, and completing a resume workshop.

18. The medium of claim 11, wherein the particular academic program comprises one or more of: a major, a certificate program, a minor, or a degree program.

19. The medium of claim 11, wherein:
the operations further comprise:
determining a target employment position for the student;
querying the employment database with the target employment position to identify a plurality of employees with the target employment position;
selecting academic programs, completed by at least one of the plurality of employees with the target employment position, as a set of candidate academic programs for the student;
analyzing coursework completed by the student in relation to coursework required for each academic program of the set of candidate academic programs to determine a level of completion, corresponding to the student, for each academic program of the set of candidate academic programs completed by at least one of the plurality of employees with the target employment position;
concurrently displaying the student's level of completion for each academic program of the set of candidate academic programs completed by at least one of the plurality of employees with the target employment position;
displaying a composite interface element for each of the set of candidate academic programs completed by at least one of the plurality of employees with the target employment position, wherein the composite interface element comprises one or more of: a button for applying for the target employment position, a button for initiating academic planning, or a drop-down menu for selecting a different target employment position;
displaying, for each academic program of the set of candidate academic programs, at least one of: an amount of time for completion, an estimated cost for completion, a number of courses for completion, or a number of credits for completion;
determining a target set of skills comprising skills associated with at least one of the plurality of employees with the target employment position, wherein the target set of skills are different from the coursework required for any of the set of candidate academic programs;
analyzing the student's skills in relation to target set of skills to determine one or more of the target set of skills that the student does not possess;
displaying the one or more of the target set of skills, associated with at least one of the plurality of employees with the target employment position, that the student does not possess;
concurrently displaying a respective link, for each particular academic program of the set of candidate academic programs, to a planning module that organizes and presents the coursework still to be completed by the student for completion of the particular academic program;
concurrently displaying the student's level of completion for each academic program comprises listing the set of candidate academic programs in a ranked order based on the student's level of completion for each candidate program of the set of candidate academic programs;
selecting the academic programs as the set of candidate academic programs for the student is further responsive to determining that each of the set of candidate academic programs has been completed by a minimum threshold number of employees with the target employment position;
selecting the academic programs as the set of candidate academic programs for the student comprises:
determining a recommendation score for each academic program of a plurality of academic programs based at least on the student's level of completion for each academic program of the plurality of academic programs;
wherein the academic programs are selected in the set of candidate academic programs based on the respective recommendation score being above a threshold value.

20. A method comprising:
determining a target employment position for a student;
querying an employment database with the target employment position to identify a plurality of employees with the target employment position;
selecting academic programs, completed by at least one of the plurality of employees with the target employment position, as a set of candidate academic programs for the student;
analyzing coursework completed by the student in relation to coursework required for each academic program of the set of candidate academic programs to determine a level of completion, corresponding to the student, for each academic program of the set of candidate academic programs completed by at least one of the plurality of employees with the target employment position;
concurrently displaying the student's level of completion for each academic program of the set of candidate academic programs completed by at least one of the plurality of employees with the target employment position;
wherein the method is performed by at least one device including a hardware processor.
